(19) United States
(12) Patent Application Publication
(10) Pub. No.: US 2025/0249780 A1
(43) Pub. Date: Aug. 7, 2025

(54) CHARGING CONTROL FOR AN ELECTRIC VEHICLE

(71) Applicant: Volvo Truck Corporation, GÖTEBORG (SE)

(72) Inventors: Marthrage Supun Nadeeshka PERERA, GÖTEBORG (SE); Simon JOSEFSSON, GÖTEBORG (SE); Albert SERRA DALMAU, GÖTEBORG (SE); Carl STORCKENFELDT, GÖTEBORG (SE); Gireesha KANAGARAJ, GÖTEBORG (SE)

(21) Appl. No.: 19/034,678

(22) Filed: Jan. 23, 2025

(30) Foreign Application Priority Data
Feb. 7, 2024 (EP) 24156339.4

(51) Int. Cl. B60L 53/66; B60L 3/00; B60L 53/62; B60L 58/12

(52) U.S. Cl. CPC B60L 53/66; B60L 3/0046; B60L 53/62; B60L 58/12; B60L 2260/54

(57) ABSTRACT

A computer system for controlling charging of an electric vehicle (EV) the computer system comprising processing circuitry configured to: perform a functionality test routine in response to the EV being connected to an Electric Vehicle Supply Equipment (EVSE) the functionality test routine being adapted to identify a charging restart functionality in the EVSE; determine, based on an outcome of the functionality test routine, an anomaly or absence of the charging restart functionality of the EVSE; and in response to determining the anomaly or absence of the charging restart functionality, control a charging rate provided by the EVSE to the EV.

### CROSS REFERENCE TO RELATED APPLICATIONS

This application claims priority to European Patent Application No. 24156339.4, filed on Feb. 7, 2024, the disclosure and content of which is incorporated by reference herein in its entirety.

### TECHNICAL FIELD

The disclosure relates generally to vehicle energy management. In particular aspects, the disclosure relates to charging control for an electric vehicle (EV). The disclosure can be applied to electric heavy-duty vehicles, such as trucks, buses, and construction equipment, among other vehicle types. The disclosure can also be applied to other EVs, such as electric marine vessels, electric construction equipment, electric personal vehicles, among other vehicle types. Although the disclosure may be described with respect to a particular vehicle, the disclosure is not restricted to any particular vehicle.

### BACKGROUND

Charging of EVs is necessary to replenish the energy stored in their batteries, ensuring continued operation and enabling sustainable and clean transportation. Certain charging periods tend to last for a longer time than what is needed in order to reach a target state of charge, SoC, of batteries in the vehicle. The batteries may therefore reach its target state of charge a relatively long time before the energy stored in the batteries are to be subsequently consumed. As a consequence, the time period between the batteries reaching a target state of charge and the vehicle being powered with energy from the batteries causes energy to continuously be depleted from the batteries. When the vehicle is ready to be operated the battery SoC will not be as high as anticipated due to this energy depletion time period. This can negatively affect the driving range, increase the frequency of charging sessions, cause potential inconvenience due to more frequent stops, increase the risk of the driver experiencing range anxiety due to concerns about running out of battery power before reaching their destination, to name a few problems.

It is in view of the above observations and others the present inventors herein are suggesting one or more improvements to the prior art of EV charging control.

### SUMMARY

Certain charging equipment, herein denoted EVSE (Electric Vehicle Supply Equipment), have the functionality of automatically restarting upon detecting a battery depletion during idle periods of the vehicle. EVSE having built-in restart functionalities can thus mitigate the energy depletion period by causing automatic restarts of the charging during idle periods. However, in some scenarios the restart functionalities do not work as intended due to anomalies such as technical malfunctions, software glitches, communication errors, incompatible systems, power supply issues, usage errors, network connectivity problems, old firmware versions, security concerns, environmental conditions, and more. In addition, restart of charging undeniably fails to function where the EVSE does not have such a functionality.

The present disclosure therefore aims to overcome the problem of handling long-term charging of EVs where the EVSE lacks automatic restart functionalities or there may exist problems with existing automatic restart functionalities due to one or more of the issues (or other related issues) mentioned above.

According to a first aspect of the disclosure there is provided a computer system for controlling charging of an EV. The computer system comprises processing circuitry configured to perform a functionality test routine in response to the EV being connected to an Electric Vehicle Supply Equipment, EVSE, the functionality test routine being adapted to identify a charging restart functionality in the EVSE; determine, based on an outcome of the functionality test routine, an anomaly or absence of the charging restart functionality of the EVSE; and in response to determining the anomaly or absence of the charging restart functionality, control a charging rate provided by the EVSE to the EV.

The first aspect of the disclosure may seek to manage undesirable battery energy losses caused by an extended idling period of the EV after a charging has been completed. Effective long-time charging is thereby enabled for EVSE lacking or experiencing problems with existing charging restart functionalities. Solving the issue of energy depletion during vehicle standby may involve technical effects related to improvements in driving range, reducing the need for frequent charging stops, alleviating concerns about range anxiety. Together these advantages ensure a more predictable and satisfactory EV experience, promoting user confidence and adoption, thereby contributing to a smoother integration of EVs into daily use.

Optionally, in some examples, the processing circuitry is configured to perform the functionality test routine by causing transmission of a plurality of different charging requests from the EV to the EVSE. A technical benefit may include being able to test a wide range of charging scenarios, identify and diagnose possible problems or lack of functionality, and ensure compatibility between the EV and the EVSE.

Optionally, in some examples, the plurality of different charging requests comprises: a first request for charging a battery of the EV, wherein the battery is adapted to be charged at a first charging rate following a response by the EVSE to the first request; and a second request for interrupting the charging of the battery effected by the first request, wherein charging of the battery is adapted to be interrupted following a response by the EVSE to the second request. A technical benefit may include being able to establish whether there is an anomaly of a charging restart functionality or whether said charging restart functionality exists within the EVSE in a way that does not require additional hardware or devices and is compatible with any suitable EVSE standard.

Optionally, in some examples, the first request comprises a first predetermined threshold value being indicative of a target for the charging of the battery, the first predetermined threshold value being a target SoC of the battery, and wherein the processing circuitry is further configured to transmit the second request in response to said first predetermined threshold value being exceeded. A technical benefit may include a more predictable behaviour of detection which leads to an improved control of the charging.

Optionally, in some examples, the processing circuitry is configured to determine the charging restart functionality as experiencing an anomaly or being absent in response to determining a charge condition following the interruption of the charging of the battery. A technical benefit may include obtaining direct input of the determined charge condition to provide an improved verification of whether the EVSE has or experiencing an anomaly with its charging restart functionality.

Optionally, in some examples, the plurality of different requests comprises a third request being configured to cause identification of an idle state of the EVSE, and the processing circuitry is configured to determine the charge condition after the EVSE having responded to the third request. A technical benefit may include determining the charge condition based on a state of the EVSE, which can be a reliable way of identifying a charging status.

Optionally, in some examples, the processing circuitry is configured to determine the charge condition in response to obtaining an indicator of a state of charge, SoC, from the battery. A technical benefit may include determining the charge condition based on the state of charge, which can be a reliable way of identifying a charging status.

Optionally, in some examples, the expected SoC value is based on battery characteristics of the battery and charging capability properties of the EVSE. A technical benefit may include offering of a variety of different characteristics/properties that can determine the charging status, which is both versatile and effective.

Optionally, in some examples, the processing circuitry is configured to control the charging rate provided by the EVSE to the EV by transmitting a reduced charging request from the EV to the EVSE involving a request for a reduced charging rate, wherein the battery is adapted to be charged at said reduced charging rate following a response by the EVSE to the reduced charging request. A technical benefit may include reducing the risk of the energy being replenished too quickly leading to an unwanted energy depletion of the battery, especially for relatively longer charging periods.

Optionally, in some examples, the reduced charging request comprises a predetermined charge threshold value being indicative of a desired final SoC for the battery. A technical benefit may include specifying an approximate final SoC value that is sufficient to continue driving, thereby improving the control of the reduced charging rate.

Optionally, in some examples, the reduced charging rate is based on an estimated upcoming idling time of the EV, the estimated upcoming idling time being obtained from one or more of user input, a mission management system, a prediction algorithm, and a geographical service provider. A technical benefit may include offering numerous different ways of providing estimates of the upcoming idling time, which improves the chances of the SoC level being higher upon a continued driving of the EV.

According to a second aspect of the disclosure there is provided an electric vehicle comprising the computer system of the first aspect.

According to a third aspect of the disclosure there is provided a computer-implemented method for controlling charging of an EV. The method comprises performing, by processing circuitry of a computer system, a functionality test routine in response to the EV being connected to an EVSE, the functionality test routine being adapted to identify a charging restart functionality in the EVSE; determining, by the processing circuitry, based on an outcome of the functionality test routine, an anomaly or absence of the charging restart functionality of the EVSE; and in response to determining the anomaly or absence of the charging restart functionality, controlling, by the processing circuitry, a charging rate provided by the EVSE to the EV.

According to a fourth aspect of the disclosure there is provided a computer program product comprising program code for performing, when executed by the processing circuitry, the method of the third aspect.

According to a fifth aspect of the disclosure there is provided a non-transitory computer-readable storage medium comprising instructions, which when executed by the processing circuitry, cause the processing circuitry to perform the method of the third aspect. The fifth aspect of the disclosure may seek to enable new vehicles and/or legacy vehicles to be conveniently configured, by software installation/update, for controlling charging of an EV in a reliable manner.

The second, third, fourth and fifth aspects of the disclosure may seek to manage undesirable battery energy losses caused by an extended idling period of the EV after a charging has been completed. Effective long-time charging is thereby enabled for EVSE lacking or experiencing problems with existing charging restart functionalities. Solving the issue of energy depletion during vehicle standby may involve technical effects related to improvements in driving range, reducing the need for frequent charging stops, alleviating concerns about range anxiety. Together these advantages ensure a more predictable and satisfactory EV experience, promoting user confidence and adoption, thereby contributing to a smoother integration of EVs into daily use.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary system diagram of an EV.

FIG. 2 is an exemplary flowchart diagram illustrating various ways of controlling charging utilizing communication between the EV and the EVSE.

FIG. 3 is an exemplary diagram illustrating SoC as a function of time using various approaches of charging control.

FIG. 4 is an exemplary illustration of a method for controlling charging of an EV.

FIG. 5 is a schematic diagram of an exemplary computer system for implementing examples disclosed herein.

### DETAILED DESCRIPTION

The detailed description set forth below provides information and examples of the disclosed technology with sufficient detail to enable those skilled in the art to practice the disclosure.

The subject matter of the present disclosure addresses the issues mentioned in the background section by way of managing undesirable battery energy losses caused by an extended idling period of the EV after a charging has been completed. This is done by introducing a functionality test routine between the EV and the EVSE in response the EV being connected to the EVSE, which is adapted to identify an existence of a charging restart functionality. Based on an outcome of the functionality test routine, an anomaly or absence of the charging restart functionality can be determined, and a charging rate provided by the EVSE to the EV can be controlled accordingly. Effective long-time charging is thereby enabled for EVSE lacking or experiencing problems with existing charging restart functionalities. Solving the issue of energy depletion during vehicle standby may involve technical effects related to improvements in driving range, reducing the need for frequent charging stops, alleviating concerns about range anxiety. Together these advantages ensure a more predictable and satisfactory EV experience, promoting user confidence and adoption, thereby contributing to a smoother integration of EVs into daily use.

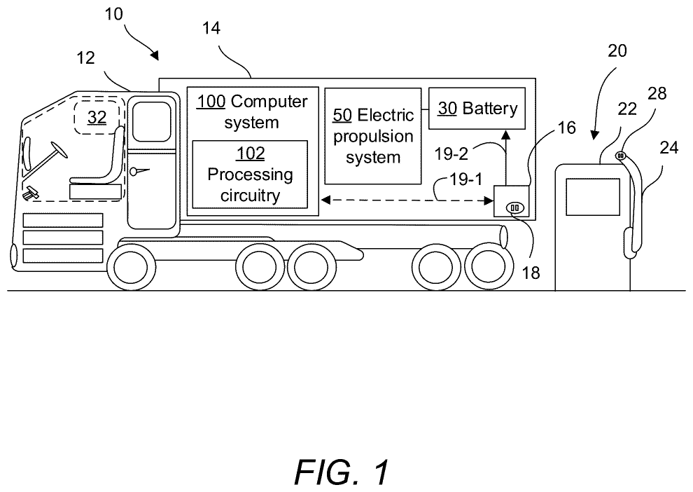

FIG. 1 is an exemplary schematic illustration of an EV 10. The EV 10 is illustrated as a heavy-duty vehicle, in this case a truck. The EV 10 may in other examples be electric buses, electric marine vessels, electric construction equipment, electric personal vehicles, among other vehicle types. Generally, the subject matter herein may be applied for EVs 10 using electric motors as their primary source of propulsion.

The EV 10 comprises a tractor unit 12 which is arranged to tow a trailer unit 14. The EV 10 comprises vehicle units and associated functionality as would be understood and expected by a skilled person, such as a powertrain, chassis, and various control systems.

The EV 10 comprises an electric propulsion system 50. The electric propulsion system 50 may be a battery electric propulsion system, a hybrid propulsion system, or other electric propulsion systems known in the art. The electric propulsion system 50 comprises one or more electric motors connected to the wheels or drivetrain of the EV 10. When the EV 10 accelerates, the electric motors draw power from a battery 30 and converts it into mechanical energy to propel the EV 10 forward. During deceleration or braking, regenerative braking systems can reverse the process, i.e., converting kinetic energy back into electrical energy and directing it back into the battery 30 for storage.

The battery 30 may be a lithium-ion battery, lithium iron phosphate battery, solid-state battery, graphene battery, sodium-ion battery, nickel-cobalt-manganese battery, aluminum-ion battery, or other battery types known in the art. The battery 30 is used to store electrical energy. The battery 30 is rechargeable and adapted to provide a source of electricity for the electric propulsion system 50. During charging, electricity from an external power source, is used to replenish the energy stored in the battery 30. In the present disclosure this external power source is an EVSE 20, depicted in FIG. 1 as a charging station. The stored electrical energy is then made available for the electric propulsion system 50 when the vehicle is in motion.

The battery 30 includes individual battery cells capable of storing the electrical energy. While the present disclosure refers to a singular battery 30 for reasons of brevity, the EV 10 typically includes a plurality of batteries 30. Subsets of the plurality of batteries are assembled into larger battery pack structures encapsulating a multitude of individual cells and batteries 30. The EV 10 may include a plurality of battery packs.

A battery management system (BMS, not shown) may be provided for monitoring, protecting and optimizing the performance of the battery 30, thereby ensuring safe and efficient operation and prolonging the lifetime expectancy of the battery 30.

The EVSE 20 refers to the infrastructure, commonly known as a charging station or charging point, that supplies electric energy for recharging the EV 10. The EVSE 20 may be a charging device adapted to provide electrical power to the EV 20. The EVSE 20 may be a public or private station. The EVSE 20 is the connection point between the electric grid and the EV 10, providing the necessary interface for charging. The EVSE 20 includes the charging station 22, a charging cable 24 with an associated connector or plug 28, and other control equipment and software. The plug 28 (male part) is adapted to fit a connector inlet 18 (female part) of a charging port 16 of the EV 10.

The EVSE 20 may be categorized as any type readily adaptable to charge EVs 20, including type 2 EVSE (“standard” charging station typically operating at 240 V) and type 3 EVSE (DC fast charging). The EVSE 20 may be adapted for both AC and DC charging.

The EVSE 20 is capable of communicating both power and data. The power is communicated via a power line of the charging cable 24 and the data via a data line. The data line may be a wired connection within the charging cable 24. The data line may alternatively or additionally be effected over a wireless communication channel. The wireless communication channel typically employs short-range communication standards, as the EV 10 would typically be close to the EVSE 20 during charging. However, long-range communication standards may alternatively be employed. Short-range communication standards include, for instance, IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, or any other form of proximity-based device-to-device radio communication signal such as LTE Direct. Long-range communication interfaces include, for instance, W-CDMA/HSPA, GSM, UTRAN or LTE.

In communication with the EVSE 20, the EV 10 utilizes on-vehicle communication interfaces 19-1, 19-2. A data communication interface 19-1 is configured to manage data connections between the processing circuitry 102 and the EVSE 20 via the charging cable 24, or optionally via wireless communication. A power communication interface 19-2 is configured to manage power connections between the battery 30 and the EVSE 20 via the charging cable 24.

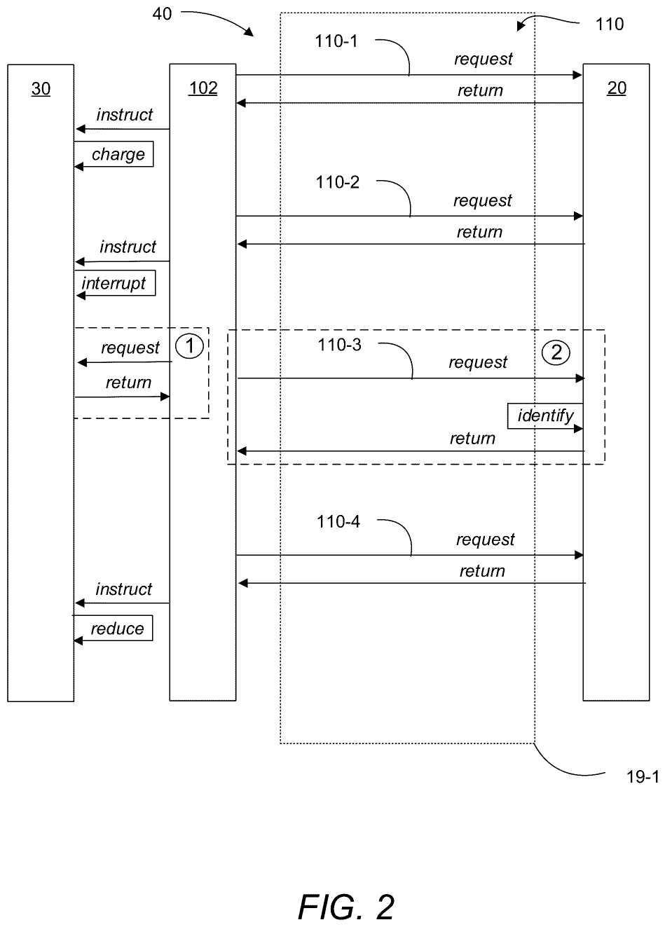

The EV 10 comprises a computer system 100 having processing circuitry 102. The processing circuitry 102 is configured for controlling charging of the EV 10, and more specifically of the battery 30. This is done by communicating with the EVSE 20. The processing circuitry 102 is configured to perform a functionality test routine when the EV 10 is connected to the EVSE 20. The functionality test routine is adapted to identify an existence of a charging restart functionality in the EVSE 20. Based on an outcome of the functionality test routine, the processing circuitry 102 is configured to determine an anomaly or absence of the charging restart functionality. Where the charging restart functionality is determined to be non-existent or experiencing an anomaly, the processing circuitry 102 is further configured to control a charging rate provided by the EVSE 20 to the EV 10. This procedure will now be explained in detail with further reference to FIG. 2.

FIG. 2 is an exemplary flowchart diagram illustrating how a functionality test routine 40 can be carried out. The components taking part in this procedure is primarily the battery 30, the processing circuitry 102 and the EVSE 20. Generally, the functionality test routine 40 involves a transmission of a plurality of different charging requests 110 from the EV 10, more specifically the processing circuitry 102 therein, to the EVSE 20. This is accordingly a software solution carried out over the on-vehicle data communication interface 19-1 as discussed herein. The requests 110 may be sent wiredly or wirelessly.

The functionality test routine 40 is advantageously integrated in and performed during the normal charging procedure of the EV 10 and does not require any excess hardware or communication modules. To this end, the computer system 100 may be an on-board system, and the processing circuitry 102 is configured to communicate with the EVSE 20 via the charging cable 24 for purposes of carrying out the functionality test routine 40 through the on-vehicle data communication interface 19-1.

The functionality test routine 40 may be performed in response to receiving input from a human-machine interface. The human-machine interface may be arranged in the cabin of the EV 10, as is shown at 32 in FIG. 1, or elsewhere in the EV 10. Alternatively, the inputs may be received from an external device operable by a driver of the EV 10. Inputs may also be received from a cloud-based service. In some examples, the functionality test routine 40 is automatically triggered upon a connection between the EV 10 and the EVSE 20 being detected.

In some examples, the charging requests 110 involve a first and second request 110-1, 110-2. These are sent between the processing circuitry 102 and the EVSE 20. The first and second requests 110-1, 110-2 involve a respective return or answer from the EVSE 20. The purpose of the first and second requests 110-1, 110-2 is to establish whether there is an anomaly of a charging restart functionality or whether said charging restart functionality exists within the EVSE 20.

The first request 110-1 is a request for charging the battery 30. This may be interpreted as an initiation of a charging procedure for the EV 20. The request for charging the battery 30 includes a requested first charging rate. The first charging rate may involve a first predetermined threshold value being indicative of a target for the charging of the battery 30. The first predetermined threshold value is a target SoC of the battery 30, i.e., a desired charging level of the battery 30 after finishing the charging, such as any percentage value of SoC. In some alternative examples, the first predetermined threshold value may be a target time during which the EV 10 is to be charged, such as one or more minutes or hours, a specified time such as 14:00 Friday, or the like. Once the EVSE 20 returns the request, for example through an ACK message, the processing circuitry 102 is configured to instruct the battery 30 to charge according to the first request 110-1. While not explicitly shown in the illustration, charging of the battery 30 is accordingly initiated over the power line from the EVSE 20 to the battery 30.

The second request 110-2 is a request for interrupting the charging of the battery 30 effected by the first request 110-1. The second request 110-2 is carried an arbitrary or predetermined time period after the charging of the battery 30 according to the first request 110-1 has been initiated. The time between the initiation of the charging and the transmission of the second request 110-2 is not necessarily important. It is sufficient to submit the second request 110-2 just as the charging has been initiated, i.e., a time above zero. This is due to the fact that the functionality test routine 40 aims to discover the charging behaviour after the interruption of the charging of the battery 30 at the first charging rate. This also means that it is not necessarily important that the first charging rate is a particular value, provided that it is above zero. In examples where the first predetermined threshold value is defined according to the above, the second request 110-2 may be transmitted in response to the first predetermined threshold value being exceeded. This corresponds to the target being reached, such as the target SoC or the target time, depending on what value is being considered. Once the EVSE 20 returns the request, for example through an ACK message, the processing circuitry 102 is configured to instruct the battery 30 to interrupt the charging over the power line.

In some examples, the charging restart functionality may be determined as experiencing an anomaly or being absent in response to determining a charge condition. The charge condition is determined following the interruption (caused by the second request 110-2) of the charging (caused by the first request 110-1) of the battery 30. Determining the charge condition aims to establish the charging behaviour once the charging has been interrupted. The charge condition may indicate whether a restart of the charging has been activated following the interruption. If this is the case the EVSE 20 has a restart charging functionality. If this not the case, however, the EVSE 20 may not have a restart charging functionality. The charge condition may also indicate to what extent or how a restart of the charging has been activated. If the charge condition indicates that charging has indeed been restarted, but not according to an expected behaviour, this may be an indication that the existing charging restart functionality is experiencing an anomaly and is not working as intended. For example, the charging may have been restarted with a lower charging rate than expected, at a later point in time than expected, or the like.

Two different approaches of determining the charge condition are explained herein and shown in FIG. 2 as (1) and (2), respectively. These may be employed separately, or optionally together. Other exemplary ways of determining a charge condition of a battery may be envisaged by the skilled person.

The first approach (1) involves obtaining an indicator of an expected SoC from the battery 30. This may involve a request for such indicator followed by a returnation, for example through an ACK message, from the battery 30. The indicator may be obtained from the BMS adapted to supervise the battery 30. The indicator may correspond to an internal state involving battery data such as capacity, voltage, SoC, health, or other relevant parameters referring to a current condition or status of the battery 30. The expected SoC of the indicator may be based on battery characteristics of the battery 30. Battery characteristics may include capacity, voltage, energy density, cycling life, self-discharge rate, charge/discharge efficiency, temperature sensitivity, safety, chemistry, or the like. The expected SoC of the indicator may be based on charging capability properties of the EVSE 20. The charging capability properties may include charging power, voltage, charging connector type, charging speeds, charging standards, network connectivity, cable length, authentication and payment details, smart charging features, safety features, or the like. The indicator may give an immediate (or possibly with some minor transmission delays) feedback as to whether a charging has been re-initiated or not, which is obtained by the processing circuitry 102. The processing circuitry 102 is accordingly updated of whether the charging restart functionality is experiencing an anomaly, being absent, or being present and functioning according to an intended restart functionality behaviour. In other possible implementations the charge condition can optionally be determined by comparing a current SoC of the battery (e.g. as obtained from the BMS generally according to the above), and compare the current SoC against an expected SoC over time.

The second approach (2) involves a third request 110-3 between the processing circuitry 102 and the EVSE 20. The third request 110-3 is configured to cause an identification of an idle state of the EVSE 20. The idle state refers to a condition when the EVSE 20 is connected and ready but not actively charging the EV 10. The third request 110-3 can thus be interpreted as asking a question to the EVSE 20 as to whether it charges the EV 10 (indicative of an existing charging restart functionality) or to what extent (indicative of an anomaly in the charging restart functionality). In response to the EVSE 20 returning a message, for example through an ACK message, to the processing circuitry 102, the charge condition can be determined.

The processing circuitry 102 has now determined whether there is an anomaly or absence of a charging restart functionality of the EVSE 20, for example utilizing the approaches related to the first and second requests 110-1, 110-2 as discussed above. The charging rate provided by the EVSE 20 to the EV 10 may accordingly be controlled.

In some examples, the processing circuitry 102 is configured to control the charging rate by transmitting a reduced charging request 110-4 from the EV 10 to the EVSE 20 involving a request for a reduced charging rate. This is shown in FIG. 2 as the last step succeeding the approaches (1) and (2) as described above. The reduced charging request 110-4 involves, similar to the other requests 110-1, 110-2, 110-3, a request to followed by a response, for example through an ACK message, from the EVSE 20. Following the response message the processing circuitry 102 is configured to instruct the battery 30 to adapt its charging rate to the reduced charging rate. The reduced charging rate is thus lower than the first charging rate, but above zero (hence the term reduced). The reduced charging rate may be effected similar to how the first charging rate was effected. By way of the reduced charging rate, it is possible to enable a delayed charging for long-term charging periods, even in cases where the EVSE 20 lacks or has an anomaly associated with its charging restart functionality.

In some examples, the reduced charging request 110-4 comprises a predetermined charge threshold value being indicative of a desired final SoC for the battery 30. The desired final SoC is typically a fully charged SoC value, although variations may apply. A fully charged SoC signifies a charge value corresponding to that the battery 30 has reached its maximum capacity, containing the highest amount of energy it can store.

In some examples, the reduced charging rate included in the reduced charging request 110-4 is based on an estimated upcoming idling time of the EV 10. The estimated upcoming idling time is an estimate of how long time the EV 10 will be charged by the reduced charging rate before energy from the battery 30 will continue to be consumed. While this is typically not exactly know, a general estimate can oftentimes be provided. For example, it may be known that a lunch break for the driver may last for approximately one hour. In another example, it may be known that the next time the EV 10 will be driven is tomorrow at 8 AM, on Friday at 1 PM, or practically any other suitable approximate time for when the EV 10 is expected to continue consuming energy from the battery 30.

The estimated upcoming idling time may be obtained from various sources. In some examples the estimated upcoming idling time is obtained from user input. The driver of the EV 10 can in these examples input to the EV 10, for example via an input device such as the human-machine interface 32 or a mobile device, the expected time before an upcoming continued driving. In some examples the estimated upcoming idling time is obtained from a mission management system. The mission management system is a centralized software or hardware solution designed to plan, monitor, and coordinate various aspects of a mission or project, such as relating to a driving schedule of the EV 10. In some examples the estimated upcoming idling time is obtained from a prediction algorithm. The prediction algorithm is a computational model designed to anticipate future events or conditions based on current and historical data. It analyzes sensor inputs, environmental factors, and past patterns to forecast potential scenarios, allowing the EV's 10 systems to proactively respond and improve the predictions of future or current vehicle charging stops. This may be particularly useful in contexts of autonomously driven vehicles or advanced driver-assistance systems (ADAS). In some examples the estimated upcoming idling time is obtained from a geographical service provider. The geographical service provider is a company or system that offers location-based services, utilizing geographic information systems (GIS) and spatial data. The geographical service provider offers solutions such as mapping, navigation, and location-based analytics relating to maps, routes, points of interest, and spatial analysis. For example, the geographical service provider may indicate that there is a traffic congestion that will last for a predetermined time period, and the reduced charging rate is thus adapted to account for the time during which the predetermined time period is pending.

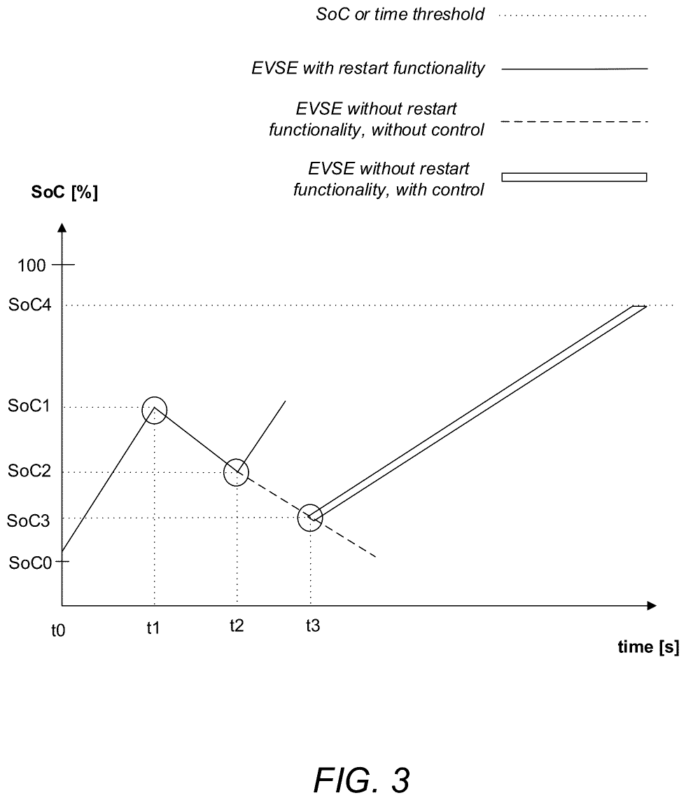

With further reference to FIG. 3, a charging procedure according to teachings explained herein is further exemplified in a diagram illustration. The diagram illustration shows SoC [%] as a function over time [s]. Three different EVSE behaviours are depicted. The first behaviour is depicted in the uniform line and corresponds to how the charging would be realized for an EVSE having a restart functionality. The second behaviour is depicted in the dashed line and corresponds to how the charging would be realized for an EVSE without a restart functionality and without a charging control according to teachings herein. It shall be noted that the second behaviour would be the same, or at least similar, in cases where the EVSE has a restart functionality, but is experiencing one or more anomalies. The third behaviour is depicted in the patterned line and corresponds to an EVSE without a restart functionality (or with a restart functionality experiencing one or more anomalies). For illustrative purposes, the time period between t0 and t2 is common for all three behaviours, and the time period between t2 and t3 is common for the second and third behaviour. Moreover, the dotted lines in the illustration refers to various time or SoC threshold values (SoC1, t1), (SoC2, t2), (SoC3, t3).

The charging between SoC0, t0 and SoC1, t1 is common for all behaviours. This corresponds to the first request 110-1 causing the battery 30 to be charged at a first charging rate. This may be done until SoC1 or t1 is reached, indicated by the first circle at threshold value SoC1, t1.

After threshold value SoC1, t1, the second request 110-2 has effected an interruption of the charging, thereby causing a subsequent depletion of energy in the battery over time until the threshold value SoC2, t2 is reached.

At threshold value SoC2, t2, indicated by the second circle, the EVSE having a restart functionality would cause a restart of the charging such that charging of the battery would be restarted typically at the same rate as the first charging rate.

At threshold value SoC2, t2, the EVSE without restart functionality, regardless of whether the charging control as described herein would be employed or not, would not cause a restart of the charging. Energy depletion from the battery would thus continue for as long as the EV would remain idle and for as long as no further action would be performed, such as triggering a manual restart of the charging. To this end, for the EVSE without control (the dashed line) would not restart, eventually leading to the SoC of the battery reaching SoC0 being a fully depleted SoC. Employing the functionality test routine as described herein (the patterned line), the EVSE would thus cause a restart of the charging at threshold value SoC3, t3, indicated by the third circle, optionally with a reduced charging rate as is depicted in this illustration. This would then be maintained until a desired SoC value is reached, which in this example is at SoC4. Effective long-time charging is thereby enabled for EVSE lacking or experiencing problems with existing charging restart functionalities.

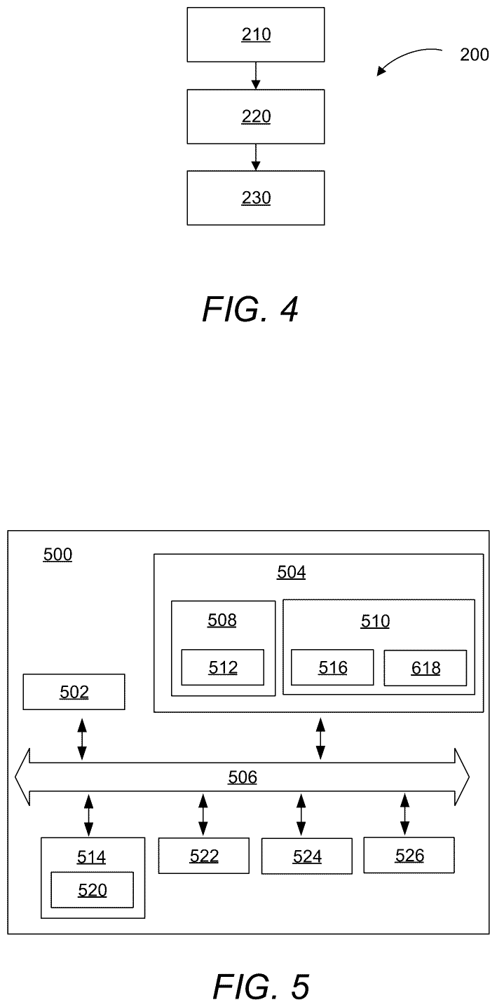

FIG. 4 is a flowchart of a computer-implemented method 200 for controlling charging of an EV. The method 200 comprises performing 210, by processing circuitry of a computer system, a functionality test routine in response to the EV being connected to an EVSE, the functionality test routine being adapted to identify a charging restart functionality in the EVSE. The method 200 further comprises determining 220, by the processing circuitry, based on an outcome of the functionality test routine, an anomaly or absence of the charging restart functionality of the EVSE. The method 200 further comprises, in response to determining the anomaly or absence of the charging restart functionality, controlling 230, by the processing circuitry, a charging rate provided by the EVSE to the EV.

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

Example 1: A computer system (100; 500) for controlling charging of an electric vehicle, EV (10), the computer system (100; 500) comprising processing circuitry (102; 502) configured to: perform a functionality test routine (40) in response to the EV (10) being connected to an Electric Vehicle Supply Equipment, EVSE (20), the functionality test routine (40) being adapted to identify a charging restart functionality in the EVSE (20); determine, based on an outcome of the functionality test routine (40), an anomaly or absence of the charging restart functionality of the EVSE (20); and in response to determining the anomaly or absence of the charging restart functionality, control a charging rate provided by the EVSE (20) to the EV (10).

Example 2: The computer system (100; 500) of example 1, wherein the processing circuitry (102; 502) is configured to perform the functionality test routine (40) by causing transmission of a plurality of different charging requests (110) from the EV (10) to the EVSE (20).

Example 3: The computer system (100; 500) of example 2, wherein the plurality of different charging requests (110) comprises: a first request (110-1) for charging a battery (30) of the EV (10), wherein the battery (30) is adapted to be charged at a first charging rate following a response by the EVSE (20) to the first request (110-1); and a second request (110-2) for interrupting the charging of the battery (30) effected by the first request (110-1), wherein charging of the battery (30) is adapted to be interrupted following a response by the EVSE (20) to the second request (110-2).

Example 4: The computer system (100; 500) of example 3, wherein the first request (110-1) comprises a first predetermined threshold value being indicative of a target for the charging of the battery (30), the first predetermined threshold value being a target SoC of the battery (30), and wherein the processing circuitry (102; 502) is further configured to transmit the second request (110-2) in response to said first predetermined threshold value being exceeded.

Example 5: The computer system of any of examples 3-4, wherein the processing circuitry (102; 502) is configured to determine the charging restart functionality as experiencing an anomaly or being absent in response to determining a charge condition following the interruption of the charging of the battery (30).

Example 6: The computer system (100; 500) of example 5, wherein the plurality of different requests (110) comprises a third request (110-3) being configured to cause identification of an idle state of the EVSE (20), and the processing circuitry (102; 502) is configured to determine the charge condition after the EVSE (20) having responded to the third request (110-3).

Example 7: The computer system (100; 500) of any of examples 5-6, wherein the processing circuitry (102; 502) is configured to determine the charge condition in response to obtaining an indicator of a state of charge, SoC, from the battery (30).

Example 8: The computer system (100; 500) of example 7, wherein the expected SoC value is based on battery characteristics of the battery (30) and charging capability properties of the EVSE (20).

Example 9: The computer system (100; 500) of any of examples 1-8, wherein the processing circuitry (102; 502) is configured to control the charging rate provided by the EVSE (20) to the EV (10) by transmitting a reduced charging request (110-4) from the EV (10) to the EVSE (20) involving a request for a reduced charging rate, wherein the battery (30) is adapted to be charged at said reduced charging rate following a response by the EVSE (20) to the reduced charging request (110-4).

Example 10: The computer system (100; 500) of example 9, wherein the reduced charging request (110-4) comprises a predetermined charge threshold value being indicative of a desired final SoC for the battery (30).

Example 11: The computer system (100; 500) of any of examples 9-10, wherein reduced charging rate is based on an estimated upcoming idling time of the EV (10).

Example 12: The computer system (100; 500) of example 11, wherein the estimated upcoming idling time is obtained from one or more of user input, a mission management system, a prediction algorithm, and a geographical service provider.

Example 13: The computer system (100; 500) of any of examples 1-12, wherein the processing circuitry (102; 502) is configured to perform the functionality test routine (40) in response to receiving input from a human-machine interface (32) of the EV (10), an external device, or a cloud-based service.

Example 14: The computer system (100; 500) of any of examples 1-13, wherein the EVSE (20) is a charging device adapted to provide electrical power via a charging cable (24) to the EV (10).

Example 15: The computer system (100; 500) of example 13, wherein the computer system (100; 500) is an on-vehicle system, and the processing circuitry (102; 502) is configured to communicate with the EVSE (20) via the charging cable (24) through an on-vehicle data communication interface (19-1).

Example 16: The computer system (100; 500) of any of examples 14-15, wherein the EVSE (20) is a DC fast-charging device.

Example 17: An electric vehicle (100; 500) comprising the computer system of any of examples 1-16.

Example 18: A computer-implemented method (200) for controlling charging of an electric vehicle, EV (10), comprising: performing (210), by processing circuitry (102; 502) of a computer system (100; 500), a functionality test routine (40) in response to the EV (10) being connected to an Electric Vehicle Supply Equipment, EVSE (20), the functionality test routine (40) being adapted to identify a charging restart functionality in the EVSE (20); determining (220), by the processing circuitry (102; 502), based on an outcome of the functionality test routine (40), an anomaly or absence of the charging restart functionality of the EVSE (20); and in response to determining the anomaly or absence of the charging restart functionality, controlling (230), by the processing circuitry (102; 502), a charging rate provided by the EVSE (20) to the EV (10).

Example 19: A computer program product comprising program code for performing, when executed by the processing circuitry (102; 502), the method of example 18.

Example 20: A non-transitory computer-readable storage medium comprising instructions, which when executed by the processing circuitry (102; 502), cause the processing circuitry (102; 502) to perform the method of example 18.

What is claimed is:

1. A computer system for controlling charging of an electric vehicle (EV) the computer system comprising processing circuitry configured to:
perform a functionality test routine in response to the EV being connected to an Electric Vehicle Supply Equipment (EVSE) the functionality test routine being adapted to identify a charging restart functionality in the EVSE;
determine, based on an outcome of the functionality test routine, an anomaly or absence of the charging restart functionality of the EVSE; and
in response to determining the anomaly or absence of the charging restart functionality, control a charging rate provided by the EVSE to the EV.

2. The computer system of claim 1, wherein the processing circuitry is configured to perform the functionality test routine by causing transmission of a plurality of different charging requests from the EV to the EVSE.

3. The computer system of claim 2, wherein the plurality of different charging requests comprises:
a first request for charging a battery of the EV, wherein the battery is adapted to be charged at a first charging rate following a response by the EVSE to the first request; and
a second request for interrupting the charging of the battery effected by the first request, wherein charging of the battery is adapted to be interrupted following a response by the EVSE to the second request.

4. The computer system of claim 3, wherein the first request comprises a first predetermined threshold value being indicative of a target for the charging of the battery, the first predetermined threshold value being a target SoC of the battery, and
wherein the processing circuitry is further configured to transmit the second request in response to said first predetermined threshold value being exceeded.

5. The computer system of claim 3, wherein the processing circuitry is configured to determine the charging restart functionality as experiencing an anomaly or being absent in response to determining a charge condition following the interruption of the charging of the battery.

6. The computer system of claim 5, wherein the plurality of different charging requests comprises a third request being configured to cause identification of an idle state of the EVSE, and the processing circuitry is configured to determine the charge condition after the EVSE having responded to the third request.

7. The computer system of claim 5, wherein the processing circuitry is configured to determine the charge condition in response to obtaining an indicator of a state of charge (SoC) from the battery.

8. The computer system of claim 7, wherein a expected SoC value is based on battery characteristics of the battery and charging capability properties of the EVSE.

9. The computer system of claim 1, wherein the processing circuitry is configured to control the charging rate provided by the EVSE to the EV by transmitting a reduced charging request from the EV to the EVSE involving a request for a reduced charging rate, wherein a battery is adapted to be charged at said reduced charging rate following a response by the EVSE to the reduced charging request.

10. The computer system of claim 9, wherein the reduced charging request comprises a predetermined charge threshold value being indicative of a desired final SoC for the battery.

11. The computer system of claim 9, wherein the reduced charging rate is based on an estimated upcoming idling time of the EV, the estimated upcoming idling time being obtained from one or more of user input, a mission management system, a prediction algorithm, and a geographical service provider.

12. An electric vehicle comprising the computer system of claim 1.

13. A computer-implemented method for controlling charging of an electric vehicle (EV) comprising:
performing, by processing circuitry of a computer system, a functionality test routine in response to the EV being connected to an Electric Vehicle Supply Equipment (EVSE) the functionality test routine being adapted to identify a charging restart functionality in the EVSE;
determining, by the processing circuitry, based on an outcome of the functionality test routine, an anomaly or absence of the charging restart functionality of the EVSE; and
in response to determining the anomaly or absence of the charging restart functionality, controlling, by the processing circuitry, a charging rate provided by the EVSE to the EV.

14. A computer program product comprising program code for performing, when executed by the processing circuitry, the method of claim 13.

15. A non-transitory computer-readable storage medium comprising instructions, which when executed by the processing circuitry, cause the processing circuitry to perform the method of claim 13.
